(19) United States
(12) Patent Application Publication
(10) Pub. No.: US 2016/0121372 A1
(43) Pub. Date: May 5, 2016

(54) CLEANING PROCESS AND CLEANING DEVICE FOR ONE OR MORE PARTS OF AN APPLICATION SYSTEM

(71) Applicant: EISENMANN SE, Boeblingen (DE)

(72) Inventors: Joerg Pfau, Boeblingen (DE); Luis Guenther, Stuttgart (DE)

(21) Appl. No.: 14/933,202

(22) Filed: Nov. 5, 2015

(30) Foreign Application Priority Data
Nov. 5, 2014 (DE) 10 2014 016 364.4

(51) Int. Cl. B08B 3/02; B05B 3/02; B05B 1/02

(52) U.S. Cl. CPC B08B 3/02; B05B 1/02; B05B 3/02

(57) ABSTRACT

A cleaning process for one or more parts of an application system by positioning one or more parts of the application system in a clewing chamber, spraying the one or more parts of the application system with a medium using a plurality of spray devices, with the medium being supplied to the spray devices from an assembly group. One or more parts of the application system may be removed from the cleaning chamber, wherein during spraying the supply of media to the spray devices takes place in a sequence having a plurality of successive phases. At least two phases of the sequence differ in terms of the supply of the at least one medium to the spray devices. A cleaning device designed to carry out the cleaning process is also provided having a control device for controlling the supply of the medium to the spray devices.

### RELATED APPLICATIONS

The present application claims the tiling benefit of German Patent Application No. 10 2014 016 364.4, filed Nov. 5, 2014, the contents of which are incorporated herein by reference.

### FIELD OF THE INVENTION

The invention relates to a cleaning process for one or more parts of aft application system, comprising at least the following process steps:
a) positioning the one or more parts of the application system in a cleaning chamber;
b) spraying the one or more parts of the application system with a medium, wherein the spraying is carried out by means of a plurality of spray devices, wherein the medium is supplied to the spray devices from an assembly group;
c) removing the one or more parts of the application system from the cleaning chamber.

The invention relates also to a cleaning device for one or more parts of an application system, having
a) a cleaning chamber;
b) a plurality of spray devices for introducing a medium into the cleaning chamber;
c) an assembly group for providing the medium for the spray devices;

d) at least one main line for supplying the medium from the assembly group to the spray devices.

### BACKGROUND OF THE INVENTION

In the coating of objects with lacquer in a spray booth, a partial stream of the coating material emerging from application units generally does not reach the object to be coated. This partial stream is referred to among experts as overspray, A large part, of the overspray is discharged from the spray booth by means of a stream of air.

However, a smaller part of the overspray settles as dirt on inner surfaces of the spray booth and especially also on the outside surfaces of the application system and in particular on the application units, so that the components contaminated with overspray have to be cleaned from time to time.

From DE 101 45 168 A1 there is known a process for automatically cleaning the outside of a costing device used for coating workpieces, wherein the coating device is sprayed with dry ice in a cleaning container, and wherein there is provided a nozzle directed at the outside of the coating device, which nozzle is arranged in the cleaning container or in the wall thereof. In DE 101 45 168 A1 it is further proposed that the nozzle is movably mounted and is displaceable and/or pivotable relative to the coating device by an automatically controlled drive device.

EP 2 056 970 B1 describes a cleaning process and a cleaning device for atomisers, in particular spray guns, wherein a mixing device is configured to supply a compressed air/cleaning agent mixture to a mixture outlet, wherein there is provided a spray device which is connected to the mixture outlet and is suitable tor spraying the cleaning mixture, wherein the spray device has a plurality of wash pipes which deliver the compressed air/cleaning agent mixture.

A disadvantage of the known cleaning, processes is inter alia the relatively high consumption of medium during the cleaning operation.

In connection with the cleaning of application units in a system for coating objects, it is known from DE 10 2012 014 212 A1 to monitor the contamination of the application units in an automated manner by means of a sensor device and to initiate the operation of cleaning an application unit in dependence on a degree of contamination of the application unit detected by means of the sensor device. The risk of cleaning being carried out too early or too late is thereby to be reduced.

### SUMMARY OF THE INVENTION

An object of the present invention is to provide a cleaning process and a cleaning device of the type mentioned at the beginning which are farther developed as compared with the processes known from the prior art.

This object may be achieved, in a cleaning process of the type mentioned at the beginning in that
e) the supply of media to the spray devices takes place in a sequence having a plurality of successive phases, wherein at least two phases of the sequence differ in terms of the supply of the at least one medium to the spray devices.

By means of such a variable use of media, the consumption of media during the cleaning operation can be reduced and/or the cleaning action can be increased. The evacuation of dirt dissolved during cleaning can also be Improved according to the invention.

Preferably, at least two phases of the sequence can differ in terms of the medium supplied to the spray devices. By using different media in the respective phases, a better dissolving action can thus be achieved and/or the consumption of comparatively expensive media, for example solvents, can be reduced.

It can be advantageous to use as the media at least two of the following: solvents, water, compressed air, steam, carbon dioxide. Carbon dioxide is preferably delivered in the form of pellets known per se.

In order further to increase the cleaning action, the number of spray devices to which a medium is supplied in a first phase of the sequence can differ from the camber of spray devices to which a medium is supplied in a second phase of the sequence.

In order to improve the efficiency of the use of the media, it is advantageous if
a) a first volume stream is supplied to a first group of spray devices and a second volume stream is supplied to a second group of spray devices, wherein the first and the second volume streams differ from one another;
b) in a first phase of the sequence, the allocation of the spray devices to the first group and to the second group is different from that in a second phase of the sequence.

It can be advantageous if the first volume stream is hot equal to zero, and if the second volume stream is at least approximately equal to zero.

There can advantageously be provided, at least between two phases in which a volume stream that is not equal to zero is in each case supplied to at least one of the spray devices, a phase in which a volume stream that is at least approximately equal to zero is supplied to all the spray devices. In this manner, the evacuation of dissolved dirt in particular can he improved further.

In an advantageous further development, the phases of the sequence can be so specified that the volume streams which are supplied to individual spray devices or groups of spray devices are so controlled that the sequence follows a geometric arrangement of the spray devices. According to this further development of the invention, the cleaning action can be increased further, it further being possible to adapt the sequences to the application system to be cleaned, or to parts thereof, as required.

In order to increase the cleaning action and/or to improve the evacuation of dirt, spray devices of different types can advantageously be used for spraying the one or more parts of the application system.

It can be advantageous to use spray devices of at least two of the following types: full jet nozzle, fan nozzle, rotary nozzle.

According to a further development of the invention, the one or more parts of the application system can be rotated about a shaft in the cleaning chamber by means of a handling unit, wherein one or more of the spray devices are arranged at least approximately perpendicularly to the shaft.

An object of the invention may be achieved in a cleaning device of the type mentioned at the beginning in that
e) the cleaning device is designed to carry out the above-described cleaning process according to the invention, wherein a control device is provided for controlling the supply of the at least one medium to the spray devices.

The advantages of the cleaning device according to the invention come about in particular analogously to the advantages of the cleaning process according to the invention.

In order to achieve a particularly efficient use of media, it can be advantageous for the assembly group to be connected on the inlet side to a plurality of supply lines carrying media.

In order to clean the one or more parts of the application system as completely as possible, at least some of the spray devices are preferably in the form of fan nozzles which are arranged around a shaft, wherein at least some of the fan nobles arranged around the shaft are oriented at least approximately perpendicularly to the shaft.

A system for coating objects can advantageously comprise at least one cleaning device according to the invention or an embodiment thereof.

It is to be understood that the aspects and objects of the present invention described above may be combinable and that other advantages and aspects of the present invention will become apparent upon reading the following description of the drawings and detailed description of the invention.

### BRIEF DESCRIPTION OF THE DRAWINGS

Further advantageous embodiments will become apparent from the following description, in which exemplary embodiments of the invention are explained in greater detail by means of the drawings, without being limited thereto. In the drawings, in each case in a simplified, schematic representation:

FIG. 1 shows a horizontal section of a partial region of a system tor coating objects;

FIG. 2 shows parts of an application system;

FIG. 3 shows a partial view of a cleaning device;

FIG. 4 shows a partial view of a cleaning device having a media supply device;

FIG. 5 shows a partial view of a cleaning device.

### DETAILED DESCRIPTION OF THE PRESENT INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

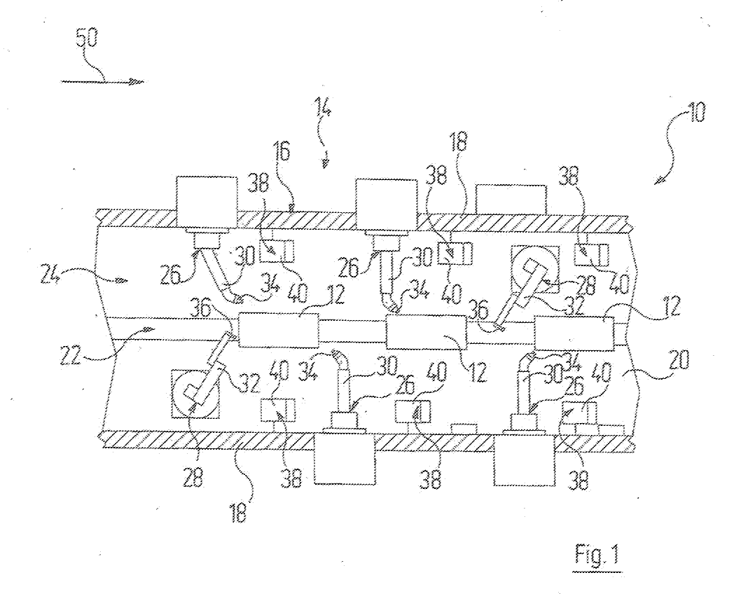

FIG. 1 shows a partial region of a lacquering system, designated as a whole by 10, as an example of a system for coating objects. In the lacquering system 10, objects 12 are provided with a coating in the form of a lacquer. In FIG. 1, the objects 12 are shown schematically as rectangles. Objects 12 to be coated can be, for example, motor vehicle bodies, body parts, machine parts or motor vehicle parts such as, for example, bumpers or the like. Examples of systems for coating objects are inter alia lacquering systems, systems for applying preservatives and/or parting agents, or systems for powder coating.

FIG. 1 shows a horizontal section of a portion 14 of a spray booth 16 beneath a booth ceiling (not shown). In the example shown, the spray booth 16 has side walls 18 which extend parallel to one another and can be closed by end faces in the region not shown in FIG. 1, the end faces having in known manner gates or locks for the objects 12. The floor of the spray booth 16 is formed substantially by a grid 20. The spray booth 16 can be terminated at the top In a manner known per se by a plenum, from which conditioned air can be passed into the interior of the spray booth 16.

In the example shown, the objects 12 to be lacquered are guided through the interior of the spray booth 16 in a continuous or intermittent movement by means of a conveyor system 22, for example in the direction indicated by the arrow 50. The nature of the conveyor system 22 is not important in the present context.

In the spray booth 12, the objects 12 to be coated are provided with a coating in the form of a lacquer by means of an application system 24.

For coating the objects 12, the application system 24 preferably comprises handling units 26, 28 on both sides of the movement path of the objects 12 on the conveyor system 22, which handling units can be in the form of handling robots or spray robots of different constructions. Likewise by way of example, four handling units in the form of jointed-arm robots 26 are provided in the portion 14 of the spray booth 16, two of which handling units are arranged on each side of the movement path of the objects 12. The jointed-arm robots shown by way of example are also referred to as articulated robots. In addition, a total of two handling units in the form of industrial robots 28 is provided, one of which is arranged on each side of the movement path of the objects 12.

Both the jointed-arm robots 26 and the industrial robots 21 have a movable robot arm 30 or 32, at the end of which there is carried an application unit 34 or 36, respectively. Each of these application units 34, 36 comprises the actual applicator, which is not specifically provided with a reference numeral in FIG. 1. The application unit 34 of the jointed-arm robot 26 shown in the example comprises, for example, a high-rotation atomiser, while the application unit 36 of the industrial robot 28 has a spray gun. In a modification, other common applicators can likewise be included in an application unit 34, 36.

As mentioned at the beginning, the overspray that is produced during coating of the objects 12 settles as dirt on inner surfaces of the spray booth 16 and preferably on the outside surfaces of the application system 24 and in particular on the application units 34, 36 and on the regions of the handling units 26, 28 adjacent thereto.

In order to remove dirt, in particular dirt resulting from overspray as described above, a plurality of cleaning devices 38 is provided along the side walls 18 of the spray booth 16.

A cleaning device 38 has at least one cleaning chamber 40 and a plurality of spray devices, which are not shown in detail in FIG. 1. The spray devices of a cleaning device 38 can he in the form of, for example, a nozzle and/or a wash pipe.

In a cleaning chamber 40, one or more parts of an application system 24 can be cleaned by means of the spray devices. In particular, the application units 34, 36 can be cleaned at least partially in a cleaning chamber 40, whereby adhering overspray is dissolved and evacuated.

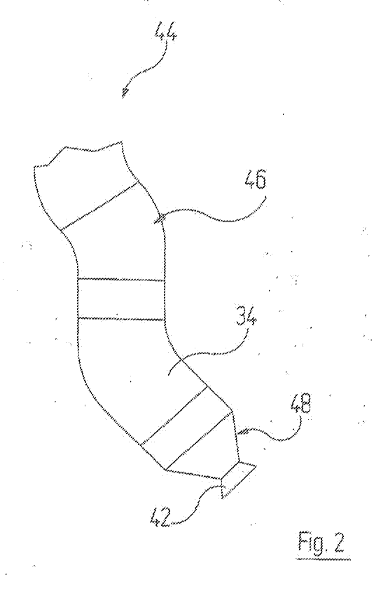

FIG. 2 shows an end portion 44 of one of the robot arms 30 shown in FIG. 1. This end portion 44 of the robot arm 30 comprises a robot hand joint 46, which in turn carries the application unit 34 in a manner known per se, the application unit here being shown by way of example in the form of a rotary atomiser 48.

The rotary atomiser 48 has a bell disk 42 and can preferably be equipped with a shaping air system, which is not shown in detail in the drawing. By means of the bell disk 42, a spray jet cloud can be produced. By means of the shaping air system, the spray jet can he regulated and the spray jet cloud can be adapted to the objects 12 to be lacquered.

The application unit 34 shown, in FIG. 2 is in the form of an atomiser with internal charging, the atomiser preferably being provided with an integrated high-voltage cascade, which is not shown in detail in the drawing. A further example of an atomiser are the application units 36 in the form of gun-type atomisers shown in FIG. 1.

The cleaning chamber 40 of a cleaning device 38 can be designed to receive part or all of the end portion 44 of a handling unit 26, 28.

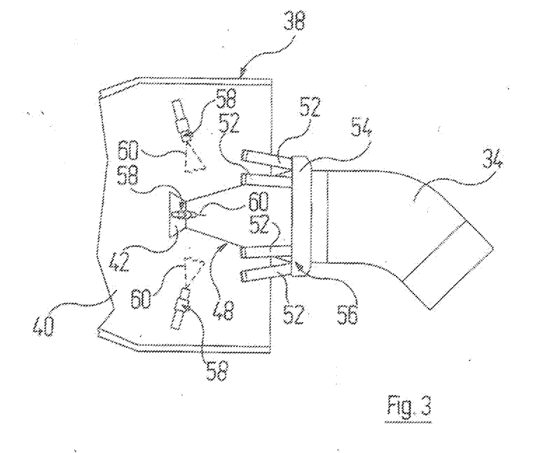

FIG. 3 shows an application unit 34 in the form of a rotary atomiser 48, which projects into a cleaning chamber 40 of a cleaning device 38. The application unit shown here is in the form of an atomiser with external charging, the charging device 56 in the example shown having a holding ring 54 which carries a plurality of external electrodes 52. The rotary atomiser 48 has a bell disk 42 and can preferably be equipped with a shaping air system, which is not shown in detail.

The cleaning device 38 shown in FIG. 3 is equipped with a plurality of spray devices in the form of nozzles 58, a medium in the form of a jet 60 being able to emerge from the spray devices, as shown in the drawing. The same or different media can emerge from different spray devices.

In the example shown, a jet 60 in the form of a cleaning jet emerges from each of the nozzles 38, the jet 60 being directed at the end portion of the application unit 34.

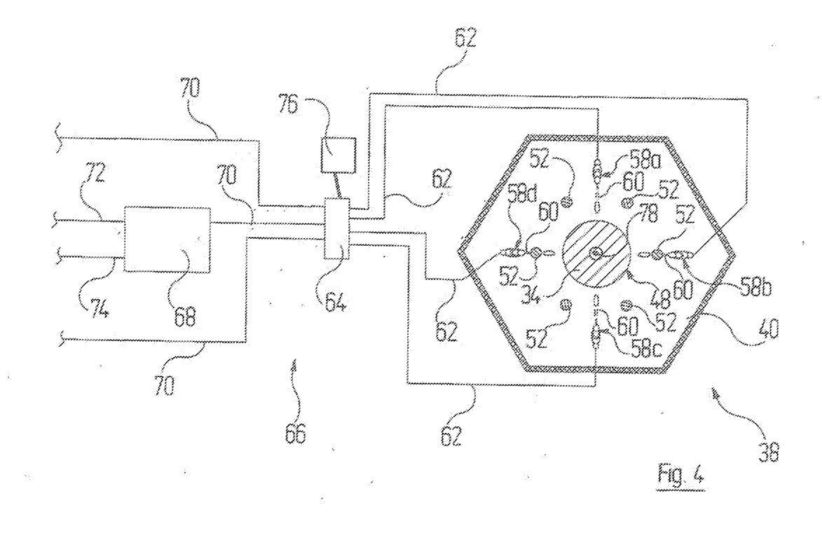

FIG. 4 shows a cleaning device 38, the cleaning chamber 40 of the cleaning device 38 being shown in a sectional view, the sectional plane being perpendicular to the shaft 78 of the application unit 34.

The parts of the application system 24 that are shown in the example also include the external electrodes 52 of an application unit 34 in the form of a rotary atomiser 48 with external charging.

In the example shown, the application unit 34 is in the cleaning chamber 40 for cleaning. In the cleaning chamber there are provided spray devices in the form of nozzles 58a, 58b, 58c, 58d, which are arranged, around the shaft 78. A medium in the form of a jet 60 emerges from each of the nozzles 58a, 58b, 58c, 58d, which jet 60 is directed at the application unit 34. In an alternative embodiment to the nozzles 58a, 58b, 58c, 58d, the spray devices can be in the form of wash pipes.

The medium used for spraying the application unit is supplied to the spray devices in the form of nozzles 58a, 58b, 58c, 58d via main lines 62. In the example shown, the nozzles 58a, 58b, 58c, 58d are directed at the shaft 78.

The application unit 34 can he rotated about the shaft 78 by means of a robot arm 30, for example.

FIG. 4 further shows a media supply device 66 having an assembly group 64 which is connected on the outlet side to the main lines 62 leading to the spray devices. A main line 62 can be designed to supply media to a single spray device or to supply media to a group of spray devices. The latter is not shown in detail in FIG. 4. On the inlet side, the assembly group 64 is connected to a plurality of supply lines 70. The assembly group 64 can have at least one media change unit known per se.

Media such as air or compressed air, water, carbon dioxide, cleaning agents and/or solvents, for example, can be supplied to the assembly group 64 via the supply lines 70. Media supplied to the assembly group 64 via the supply lines 70 can be fed from the assembly group 64, mixed or unmixed, to one or more main lines 62.

A functional group 68 which is connected on the outlet side to a supply line 70 can be provided upstream of the assembly group 64. The functional group 68 is connected on the inlet side at least to a first feed line 72 and to a second feed line 74.

The functional group 68 can provide a media mixture for the assembly group 64, a medium supplied by means of the first feed line 72 being mixed in the functional group 68 with at least one further medium supplied by means of the second feed line 74.

In an alternative embodiment, the functional group 68 can be in the form of, for example, a hot water cleaning device, in particular a low-pressure hot water cleaning device, and preferably have a sensor unit, which is not shown in detail. In this embodiment, the feed lines 72 and 74 can be designed to supply water or current.

The media feed device 66 shown in FIG. 4 has a control device 76 which, in the example shown, is coupled to the assembly group 64 and is designed to control the supply of media to the spray devices.

By means of the control device 76, the supply of media to individual spray devices and/or the supply of media to blocks of spray devices can be controlled. A block of spray devices is preferably formed by a plurality of spray devices which are connected to the assembly group 64 via a common main line.

The spray devices of the cleaning device 38 can be activated, for example, by means of the control device 76 shown in FIG. 4 in defined sequences. In particular the supply of media to the spray devices is thereby controlled according to the defined sequences.

The defined sequences which are used for the control are subdivided into a plurality of chronologically successive phases.

A sequence can be defined for example, in that, in a first phase, a different medium is supplied via one or more main lines 62 than in a second phase.

Alternatively or in addition, a sequence can be defined in that the at least one volume stream, relating to a medium, that is supplied to one or more spray devices is set differently in a first phase martin a second phase. Both the volume stream itself and the allocation of one or more spray devices to a volume stream can be varied.

Alternatively or in addition, a sequence can be defined in that the number of spray devices to which a medium is supplied in a first phase differs from the number of spray devices to which a medium is supplied in a second phase.

Thus, for example, a medium can be supplied to spray devices 58a and 58b in a first phase, while a medium is supplied to spray devices 58c and 58d in a second phase. Furthermore, a medium can be supplied, for example, to spray devices 58a and 58c in a first phase and to spray devices 5.8b and 58d in a second phase. By means of these or further combinations, it is also possible, for example, to form a sequence of four or any other number of phases.

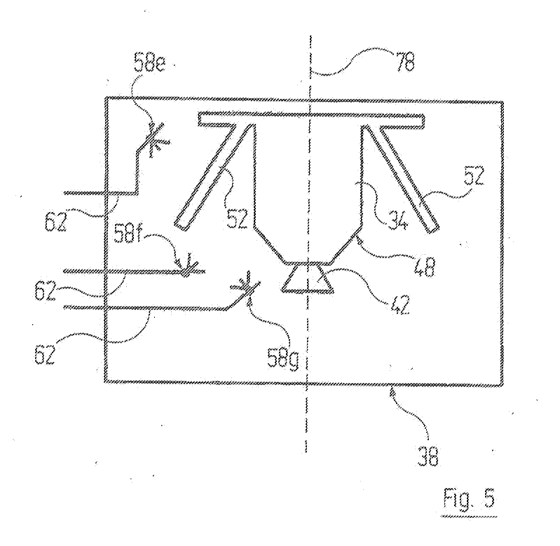

A sequence can also be defined in such a manner that the spray devices are activated in a geometric sequence. For example, opposite spray devices can be activated in succession or in different phases. In a further example, the spray device can be activated in succession around a shaft; for example, it is possible to activate first nozzle 58a, in a later phase nozzle 58b, later again nozzle 58c and later again nozzle 58d. Or, for example, it is possible to activate first nozzles 58b and 58c, in a later phase nozzles 58c and 58d and later again nozzles 58d and 58a. Or, for example, it is possible to activate first the nozzle 58e shown in FIG. 5 and any further nozzles oriented at the same angle or further nozzles arranged at the same height, in a later phase nozzle 58f and any further nozzles oriented at the same angle or further nozzles arranged at the same height, and later again nozzle 58g and any further nozzles oriented at the same angle or further nozzles arranged at the same height.

A sequence can also be defined, for example, in such a manner that a medium is supplied to a first group of spray devices in a first phase while no medium is supplied to a second group of spray devices, and in a second phase no medium is supplied to the first group of spray devices while a medium is supplied to the second group of spray devices.

A sequence can also be defined by supplying via all the main lines 62 of the cleaning device 38 a different medium in a first phase than in a second phase.

FIG. 5 shows, in a highly schematic representation, a portion of a cleaning device 38 as well as a portion of an application unit 34, which in the example is in the form of a rotary atomiser 48 having a bell disk 42 and having a plurality of external electrodes 52. The cleaning device 38 has a plurality of spray devices in the form of nozzles 58e, 58f, 58g, which are connected to main lines 62. The nozzles 58e, 58f, 58g are each oriented at different angles relative to the shaft 78 of the application unit. Further nozzles, not shown in FIG. 5, which are arranged around the shaft 78 can be provided, it being possible for the orientation of these nozzles that are not shown in FIG. 5 relative to the shaft 78 to correspond to the orientation of the nozzles 58e, 58f, 58g that are shown in FIG. 5 to the shaft 78.

The nozzles 58, 58a, 58b, 58c, 58d, 58e, 58f, 58g can be in the form of, for example, full jet nozzles, fan nozzles and/or rotary nozzles, it being possible for nozzles of different types to he provided in a cleaning device 38. Alternatively or in addition, further washing devices can be provided in the cleaning device 38.

An idea underlying the invention can be summarised as follows: The present invention relates to a cleaning process for one or more parts of an application system 24, comprising at least the following process steps: positioning the one or more parts of the application system in a cleaning chamber 40, spraying the one or more parts of the application system 24 with a medium, wherein the spraying is carried out by means of a plurality of spray devices, and wherein the medium is supplied to the spray devices from an assembly group 64, removing the one or more parts of the application system 24 from the cleaning chamber 40, wherein, within the context of the process step of spraying, the supply of media to the spray devices takes place in a sequence having a plurality of successive phases, wherein at least two phases of the sequence differ in terms of the supply of the at least one medium to the spray devices. The invention relates also to a cleaning device 38 designed to carry out the cleaning process, wherein a control device 76 is provided for controlling the supply of the at least one medium to the spray devices. The invention permits highly efficient use of media. Furthermore, both the dissolving action and the evacuation of dissolved dirt can be improved by means of the invention.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

1. A cleaning process for one or more part's of an application system comprising:
a) positioning one or more parts of the application system in a cleaning chamber;
b) spraying the one or more parts of the application system with a medium, wherein the spraying is carried out by a plurality of spray devices, wherein the medium is supplied to the spray devices from an assembly group;
c) removing the one or more parts of the application system from the cleaning chamber,
wherein
d) the supply of media to the spray devices takes place in a sequence having a plurality of successive phases, wherein at least two phases of the sequence differ in terms of the supply of the at least one medium to the spray devices.

2. The cleaning process according to claim 1, wherein at least two of the phases differ in terms of the medium supplied to the spray devices.

3. The cleaning process according to claim 2, wherein at least two of the following are used as media: solvents, water, compressed air, steam, carbon dioxide.

4. The cleaning process according to claim 1, wherein, the number of spray devices to which a medium is supplied in a first phase of the sequence is different from the number of spray devices to which a medium is supplied in a second phase of the sequence.

5. The cleaning process according to claim 1, wherein
a) a first volume stream is supplied to a first group of spray devices and a second volume stream is supplied to a second group of spray devices, wherein the first and the second volume streams differ from one another;
b) in a first phase of the sequence, the allocation of the spray devices to the first group and to the second group is different from that in a second phase of the sequence.

6. The cleaning process according to claim 5, wherein the first volume stream is not equal to zero, and in that the second volume stream Is at least approximately equal to zero.

7. The cleaning process according to claim 1, wherein there is provided, at least between two phases in which a volume stream that is not equal to zero is supplied to at least one of the spray devices, a phase in which a volume stream that is at least approximately equal to zero is supplied to all the spray devices.

8. the cleaning process according to claim 1, wherein the phases of the sequence are so specified that the volume streams which are supplied to individual spray devices or groups of spray devices are so controlled that the sequence follows a geometric arrangement of the spray devices.

9. The cleaning process according to claim 1, wherein spray devices of different types are used for spraying the one or more parts of the application system.

10. The cleaning process according to claim 9, wherein spray devices according to at least two of the following types are used: full jet nozzle, fan nozzle, rotary nozzle.

11. The cleaning process according to claim 1, wherein the one or more parts of the application system are rotated in the cleaning chamber by means of a handling unit, wherein, the rotation takes place about a shaft, to which shaft one or more of the spray devices are arranged at least approximately perpendicularly.

12. A cleaning device for one or more parts of an application system comprising:
a) a cleaning chamber;
b) a plurality of spray devices for introducing a medium into the cleaning chamber;
c) an assembly group for providing the medium for the spray devices;
d) at least one main line for supplying the medium from the assembly group to the spray devices,
wherein
e) the cleaning device is designed to carry out the cleaning process according to claim 1, wherein a control device is provided for controlling the supply of the at least one medium to the spray devices.

13. The cleaning device according to claim 12, wherein the assembly group is connected on an inlet side to a plurality of supply lines carrying media.

14. The cleaning device according to claim 12, wherein at least some of the spray devices are In the form of tan nozzles which are arranged about a shaft, wherein at least some of the fan nozzles arranged around the shaft are oriented at least approximately perpendicularly to the shaft.

15. A system for coating objects, comprising at least one cleaning device according to claim 12.
